(19) United States
(12) Patent Application Publication
(10) Pub. No.: US 2010/0050212 A1
(43) Pub. Date: Feb. 25, 2010

(54) METHOD FOR DISPLAYING TELEVISION PROGRAM AND TELEVISION USING THE SAME

(75) Inventors: Jia-Lin Yang, Taipei (TW); Fou-Ming Liou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/498,374

(22) Filed: Jul. 7, 2009

(30) Foreign Application Priority Data
Aug. 25, 2008 (TW) 97132432

(51) Int. Cl. H04N 5/445

(52) U.S. Cl. 725/46; 725/47; 348/563; 348/E05.099

(57) ABSTRACT

A method for displaying a television program and a television using the same are provided. In the method, a user's identity is identified first. Then, a television program in a predetermined channel is provided according to the user's identity.

### CROSS-REFERENCE TO RELATED APPLICATION

This application claims the priority benefit of Taiwan application serial no. 97132432, filed on Aug. 25, 2008. The entirety of the above-mentioned patent application is hereby incorporated by reference herein and made a part of specification.

### BACKGROUND OF THE INVENTION

1. Field of the Invention

The invention relates to a method for displaying a television program and a television using the same and, more particularly, to a method for displaying a television program in a predetermined channel according to a user's identity and a television using the same.

2. Description of the Related Art

The entertainment of most people is to stay at home, watch TV and enjoy pressing buttons of a remote controller at random. To satisfy different watching groups, various television programs such as cartoons, theaters, variety, news, teaching and learning, sports and children's programs are provided. Each kind of program has its own characters and showing modes. Since there are various kinds of programs, people have to pay much time in switching channels to find their preferred programs, and this disturb many people.

In addition, every country establishes a classification system and laws for media programs to prevent children and teenagers from being negatively affected by television programs. However, since both parents go out for work every day in most families nowadays, they have no time to watch television with their children and select television programs for the children. Thus, it is not only easy for the children to spend excessive time in watching television, but also easy for them to watch improper television programs. If that happens, the children and teenagers having low judging ability and high imitating ability may learn improper content from the improper television programs.

### BRIEF SUMMARY OF THE INVENTION

One objective of the invention is to provide a method for displaying a television program. By utilizing the method, the television program in a predetermined channel may be provided according to a user's identity, and channels and television programs may be selected according to the user's identity.

Another objective of the invention is to provide a television using the method.

Based on the above and other objectives, the invention provides a method for displaying a television program. In the method, the user's identity is determined first. Then, the television program of the predetermined channel is provided according to the user's identity.

Based on the above and other objectives, the invention provides a television including a user identifying device and a program display control device. The user identifying device is used to determine the user's identity to obtain an identifying result. The program display control device is used to provide the television program in the predetermined channel according to the identifying result.

According to the method for displaying the television program in an embodiment of the invention, the predetermined channel is selected from a personalized channel program guide.

According to the television in an embodiment of the invention, the program display control device further stores a personalized channel program guide, and the predetermined channel is selected from the personalized channel program guide.

According to the method for displaying the television program in an embodiment and the television in an embodiment of the invention, the personalized channel program guide is established by recording the channels and time periods normally watched, setting preferred channels and watching time periods by the user or matching a user's personalized setting with the television program information in an electronic program guide (EPG).

According to the method for displaying the television program in an embodiment and the television in an embodiment of the invention, the personalized setting includes the user's age, the television program classes allowed to be watched by the user according to a television program classification system, the preferred channels and watching time periods or preferred types of television programs of the user.

According to the method for displaying the television programs in an embodiment and the television in an embodiment of the invention, the personalized setting includes the channels and television programs that an administrator set.

According to the television in an embodiment of the invention, the user identifying device includes a fingerprint identifier, a biology identifier or a pupil identifier.

According to the television in an embodiment of the invention, the user identifying device is disposed on the remote controller of the television.

In the invention, the user's identity is determined first, and then the television program in the predetermined channel is provided according to the user's identity. Thus, much time consumed in switching channels for finding preferred television programs is saved. Since the television program in the predetermined channel is provided according to the user's identity, channels and even television programs may be selected according to the user's identity. This may achieve the objective of classifying media programs and preventing the children and teenagers having low identifying ability and high imitating ability from learning improper content from improper programs.

These and other features, aspects and advantages of the present invention will become better understood with regard to the following description, appended claims, and accompanying drawings.

### BRIEF DESCRIPTION OF THE DRAWINGS

FIG. 1 is a main block diagram showing a television in an embodiment of the invention.

FIG. 2 is an embodiment of the personalized channel program guide 108.

FIG. 3 is another main block diagram showing the television in another embodiment of the invention.

FIG. 4 is a flow chart showing the method for displaying the television program in an embodiment of the invention.

### DETAILED DESCRIPTION OF THE EMBODIMENTS

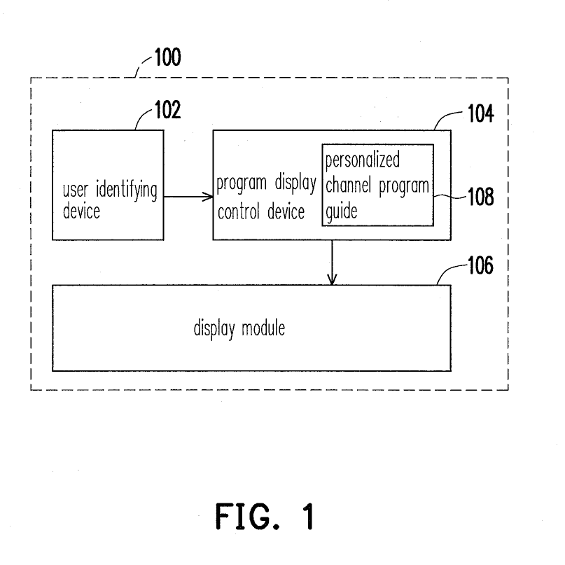

FIG. 1 is a main block diagram showing a television in an embodiment of the invention. As shown in FIG. 1, the element denoted by 100 is a television, and it includes a user identifying device 102, a program display control device 104 and a display module 106. The user identifying device 102 is used to identify the user's identity and obtain an identifying result. The program display control device 104 is used to provide a television program in a predetermined channel for the user via the display module 106 according to the identifying result. In the embodiment, the program display control device 104 stores a personalized channel program guide 108, and the predetermined channel is selected from the personalized channel program guide 108. In addition, the user identifying device 102 includes a fingerprint identifier, a biology identifier or a pupil identifier. To facilitate the identifying process, the user identifying device 102 could be disposed on the case (not shown) of the television 100 or outside the television 100.

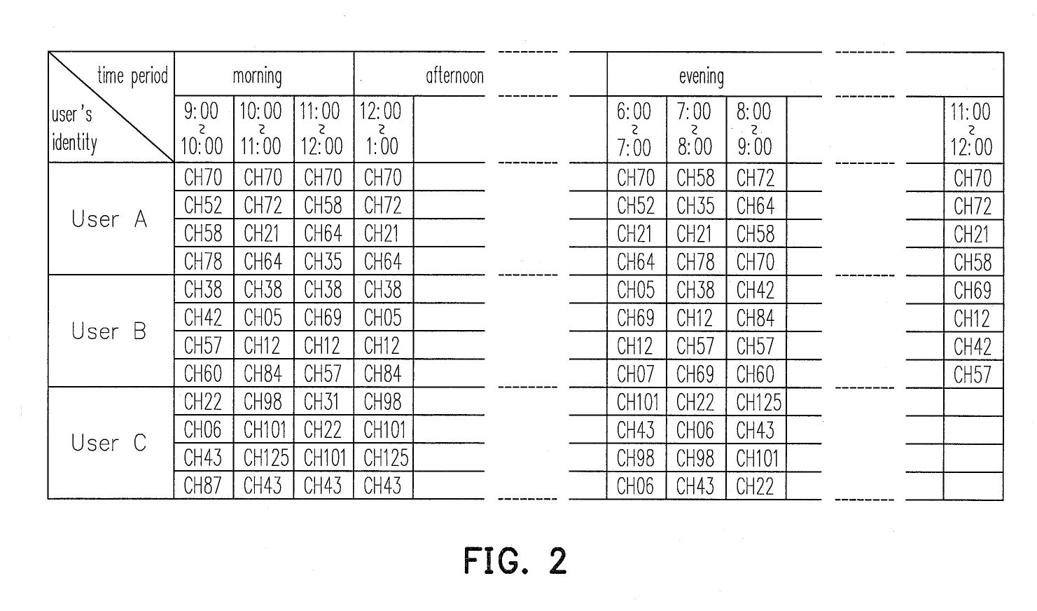

FIG. 2 is an embodiment of the personalized channel program guide 108. As shown in FIG. 2, the personalized channel program guide 108 is a watching channel guide obtained according to different users' identities and watching time periods. As shown in FIG. 1 and FIG. 2, for example, when a user wants to watch television programs from nine to ten in the morning, and after the identifying process, he or she is identified by the program display control device 104 to be the user A in the personalized channel program guide 108. Thus, the program display control device 104 chooses channel (CH) 70, CH 52, CH 58 or CH 78 which is usually watched by the user at this time period, broadcasts the television programs in the selected channels to the user via the display module 106 and allows the user to switch channels between the four channels. Thus, the user may find his preferred television program quickly without consuming much time in switching channels.

The personalized channel program guide 108 may be established in various modes. For example, it may be established by recording channels and watching time periods normally watched by every user by the program display control device 104, setting preferred channels and watching time periods by every user or combining the two modes above. This depends on actual requirements. In FIG. 2, the personalized channel program guide 108 also may be an exclusive watching channel guide of every user.

In addition, although FIG. 2 shows an aspect of the personalized channel program guide 108, a person having common knowledge in the art should know that the personalized channel program guide 108 is not limited thereto. For example, the personalized channel program guide 108 also may be achieved by comparing the personalized setting of the user with television program information in the EPG. Since the EPG may provide much television program information such as the television program guide for latest several weeks, television program names, television program types, movie introductions, main actor introductions, classes of the television programs under the classification system and so on, the personalized channel program guide 108 may be achieved by matching the television program information with the personalized setting of the user such as the user's age, the classes of the television programs allowed to be watched by the user according to a television program classification system, the user's preferred channels and watching time periods or preferred types to obtain the preferred channels and television programs of the user, or obtain the proper channels or television programs of the user.

The personalized setting may be set by an administrator to set the allowable channels and television programs for the user. The administrator may be a parent. To prevent a non-administrator from modifying the personalized setting, the user privilege also may be set. Thus, only the administrator may modify the personalized setting.

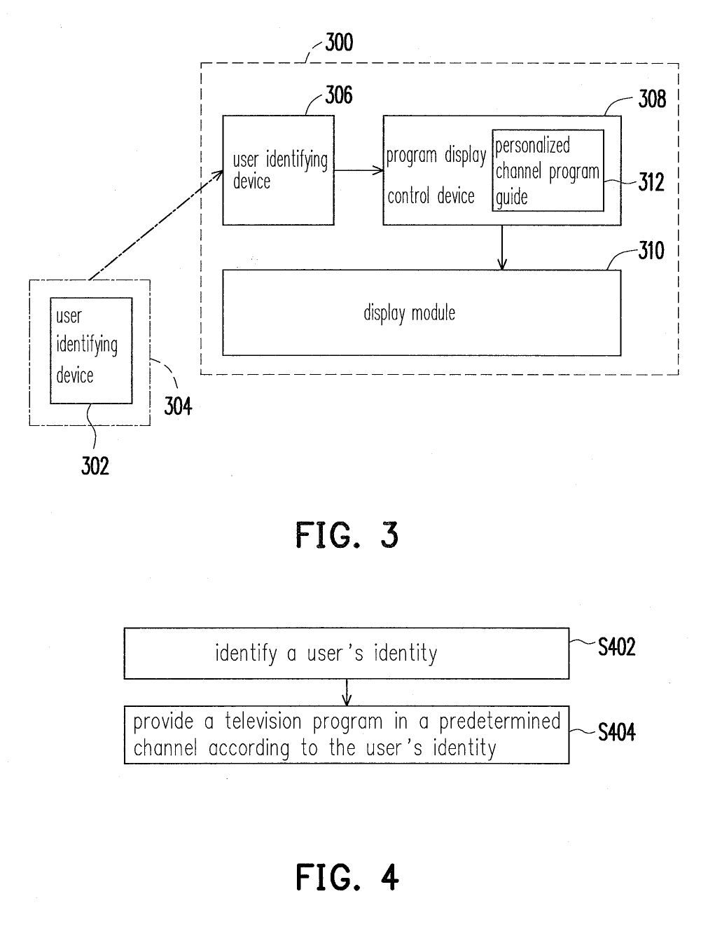

FIG. 3 is another main block diagram showing the television in an embodiment of the invention. In FIG. 3, the element denoted by 300 is the television, and it also includes a user identifying device 302, a program display control device 308 and a display module 310. The program display control device 308 may store a personalized channel program guide 312. The difference between the televisions shown in FIG. 3 and FIG. 1 is that the user identifying device 302 in FIG. 3 is disposed on the remote controller 304 of the television, and the television 300 also has a wireless signal receiving device 306 for receiving identifying data sent by the remote controller 304 and transmitting it to the program display control device 308.

A basic operation mode of the invention may be concluded according to the above embodiments. FIG. 4 is a flow chart showing the method for displaying the television program in an embodiment of the invention. In the method in FIG. 4, first, a user's identity is identified (as shown in step S402). Then, a television program in a predetermined channel is provided according to the user's identity (as shown in step S404).

To sum up, in the invention, the user's identity is identified first. Then, a television program in a predetermined channel is provided according to the user's identity. Thus, much time consumed in switching channels for finding preferred television programs is saved. Since the television program of the predetermined channel is provided according to the user's identity, channels and even television programs may be selected according to the user's identity. This may achieve the objective of classifying media programs and preventing the children and teenagers having low judging ability and high imitating ability from learning improper content from improper programs.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for displaying a television program, comprising:
identifying a user's identity; and
providing a television program in a predetermined channel according to the user's identity.

2. The method for displaying the television program according to claim 1, wherein the predetermined channel is selected from a personalized channel program guide.

3. The method for displaying the television program according to claim 2, wherein the personalized channel program guide is established by recording the channels and time periods normally watched, setting preferred channels and watching time periods by the user or matching a user's personalized setting with the television program information in an electronic program guide (EPG).

4. The method for displaying the television program according to claim 3, wherein the personalized setting comprises the user's age, the television program classes allowed to be watched according to a television program classification system, the preferred channels and the watching time periods or preferred types of television programs of the user.

5. The method for displaying the television program according to claim 3, wherein the personalized setting comprises the channels and television programs that an administrator set.

6. The method for displaying the television program according to claim 1, wherein the method for identifying the user's identity comprises identifying by a user identifying device.

7. The method for displaying the television program according to claim 6, wherein the user identifying device comprises a fingerprint identifier, a biology identifier or a pupil identifier.

8. The method for displaying the television program according to claim 6, wherein the user identifying device is disposed on a remote controller of a television.

9. A television, comprising:
a user identifying device for identifying a user's identity to obtain an identifying result; and
a program display control device for providing a television program in a predetermined channel according to the identifying result.

10. The television according to claim 9, wherein the program display control device further stores a personalized channel program guide, and the predetermined channel is selected from the personalized channel program guide.

11. The television according to claim 10, wherein the personalized channel program guide is established by recording the channels and time periods normally watched, setting preferred channels and watching time periods by the user, or matching a user's personalized setting with television program information of an EPG.

12. The television according to claim 11, wherein the personalized setting comprises the user's age, the television program classes allowed to be watched according to a television program classification system, the preferred channels and the watching time periods or preferred types of television programs of the user.

13. The television according to claim 11, wherein the personalized setting comprises the channels and television programs that an administrator set.

14. The television according to claim 9, wherein the user identifying device comprises a fingerprint identifier, a biology identifier or a pupil identifier.

15. The television according to claim 9, wherein the user identifying device is disposed on a remote controller of the television.
